(19) United States
(12) Patent Application Publication
(10) Pub. No.: US 2010/0216943 A1
(43) Pub. Date: Aug. 26, 2010

(54) HYDROPHILICIZED HYPERBRANCHED POLYURETHANES

(75) Inventors: Pedro Cavaleiro, Viersen (DE); Sebastian Sonnhalter, Castrop-Rauxel (DE); Matthias Seiler, Griesheim (DE); Stefan Bernhardt, Offenbach (DE); Markus Schwarz, Haltern am See (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/682,126

(22) PCT Filed: Sep. 22, 2008
(86) PCT No.: PCT/EP2008/062595

§ 371 Date: Apr. 8, 2010

(30) Foreign Application Priority Data
Oct. 15, 2007 (DE) 10 2007 049 587.2

(51) Int. Cl. C08L 75/08; C08G 18/08

(52) U.S. Cl. 524/590; 528/60

(57) ABSTRACT

The invention relates to hydrophilicized hyperbranched polyurethanes, to the preparation thereof and to the use thereof as dispersants, in particular for dispersing solids.

The invention relates to hydrophilicized hyperbranched polyurethanes, to the preparation thereof and to the use thereof as dispersants, in particular for dispersing solids.

Hyperbranched polymers are already known. C. Gao Hyperbranched polymers: from synthesis to applications Prog. Polym. Sci. 29 (2004) 183-275 summarizes the current prior art in this field and deals in particular with the different synthesis variants and the various fields of application of hyperbranched polymers. Here, the use of isophorone diisocyanate for the preparation of hyperbranched polyurethanes is, inter alia, discussed.

EP 1,026,185 A1 discloses a process for the preparation of dendritic or highly branched polyurethanes by reacting diisocyanates and/or polyisocyanates with compounds having at least two groups which react with isocyanates, where at least one of the reactants has functional groups with varying reactivity towards the other reactant, and the reaction conditions are chosen such that, in each reaction step, in each case only certain reactive groups react with one another.

Preferred isocyanates include, inter alia, aliphatic isocyanates, such as isophorone diisocyanate. Examples of the compounds having at least two groups which are reactive with isocyanates are propylene glycol, glycerol, mercaptoethanol, ethanolamine, N-methylethanolamine, diethanolamine, ethanolpropanolamine, dipropanolamine, diisopropanolamine, 2-amino-1,3-propanediol, 2-amino-2-methyl-1,3-propanediol and tris(hydroxymethyl)aminomethane.

The polyurethanes obtainable by the process are to serve as crosslinkers for polyurethanes or as building block for other polyaddition or polycondensation polymers, as phase promoter, thixotropic agent, nucleating reagent or as active ingredient carrier or catalyst support.

DE 100 30 869 A1 describes a process for the preparation of multifunctional polyisocyanate polyaddition products, comprising
(i) preparation of an addition product (A) by reacting a
   a) at least trifunctional component (a1) which is reactive with isocyanate groups or a difunctional component (a2) which is reactive with isocyanate groups or a mixture of components (a1) and (a2) with
      b) di- or polyisocyanate,
         where the reaction ratio is chosen so that, on average, the addition product (A) contains one isocyanate group and more than one group which is reactive with isocyanate groups,
(ii) if desired intermolecular addition reaction of the addition product (A) to give a polyaddition product (P) which contains, on average, one isocyanate group and more than two groups which are reactive with isocyanate groups and
(iii) reaction of the addition product (A) or of the polyaddition product (P) with an at least difunctional component (c) which is reactive with isocyanate groups.

Examples of the compound (a) are, inter alia, glycerol, trimethylolmethane and 1,2,4-butanetriol. A preferred diisocyanate (b) is isophorone diisocyanate.

The polyisocyanate polyaddition products obtainable by the process are proposed in particular for the preparation of paints, coatings, adhesives, sealing masses, moulding elastomers and foams.

WO 2004/101624 discloses the preparation of dendritic or hyperbranched polyurethanes through
1) reaction of di- or polyols which have at least one tertiary nitrogen atom and at least two hydroxyl groups with varying reactivity towards isocyanate groups, with di- or polyisocyanates, such as, for example, isophorone diisocyanate, to give an addition product, where the di- or polyols and di- or polyisocyanates are chosen so that the addition product has, on average, one isocyanate group and more than one hydroxyl group or one hydroxyl group and more than one isocyanate group,
2) reaction of the addition product from step 1) to give a polyaddition product through intermolecular reaction of the hydroxyl groups with the isocyanate groups, where firstly it is also possible to carry out the reaction with a compound containing at least two hydroxyl groups, mercapto groups, amino groups or isocyanate groups,
3) if desired reaction of the polyaddition product from step 2) with a compound containing at least two hydroxyl groups, mercapto groups, amino groups or isocyanate groups.

The polyaminourethanes obtainable by the process are proposed as crosslinkers for polyurethane systems or as building block for other polyaddition or polycondensation polymers, as phase promoters, as rheology auxiliaries, as thixotropic agents, as nucleating reagent or as active ingredient carrier or catalyst support.

WO 02/068553 A2 describes a coating composition containing
1) a carbamate resin with a hyperbranched or stellate polyol nucleus with a first chain section based on a polycarboxylic acid or a polycarboxylic anhydride, with a second chain section based on an epoxide and with carbamate groups on the nucleus and/or the second chain section and
2) a second resin which has reactive groups which can react with the carbamate groups of the carbamate resin.

The polyol nucleus can be obtained by reacting a first compound which contains more than 2 hydroxy groups, such as, for example, 1,2,6-hexanetriol, with a second compound which contains one carboxyl group and at least two hydroxy groups.

Introduction of the carbamate groups can be achieved through reaction with aliphatic or cycloaliphatic diisocyanates. Within the context of a longer list, 2,2,4- and 2,4,4-trimethyl-1,6-diisocyanatohexane and isophorone diisocyanate are, inter alia, specified here.

WO 97/02304 relates to highly functionalized polyurethanes which are composed of molecules with the functional groups A(B)ₙ, where A is an NCO group or a group which is reactive with an NCO group, B is an NCO group or a group which is reactive with an NCO group, A is reactive with B, and n is a natural number and is at least 2. The preparation of the monomer A(B)ₙ can take place, for example, starting from isophorone diisocyanate.

For dispersing solids (e.g. fillers, dyes or pigments) in liquid media, use is generally made of dispersant in order to achieve effective dispersion of the solids, to reduce the mechanical shear forces required for the dispersion and at the same time to realize the highest possible degrees of filling. The dispersants assist the breaking up of agglomerates, wet and/or coat, as surface-active materials, the surface of the particles to be dispersed and stabilize them against undesired reagglomeration.

In the production of paints, varnishes, printing inks and other coating materials, dispersants facilitate the incorporation of solids, such as, for example, fillers and pigments, which, being important formulation constituents, essentially determine the optical appearance and the physicochemical properties of such systems. For optimum utilization, these solids must firstly be distributed uniformly in the formulations, and secondly the distribution achieved must be stabilized.

A large number of different substances is nowadays used as dispersants for solids. Besides very simple, low molecular weight compounds, such as, for example, lecithin, fatty acids and salts thereof and alkylphenol ethoxylates, more complex high molecular weight structures are also used as dispersants. Here, it is specifically amino- and amido-functional systems which are used widely.

U.S. Pat. No. 4,224,212, EP-0 208 041, WO-00/24503 and WO-01/21298 describe, for example, dispersants based on polyester-modified polyamines. DE-197 32 251 describes polyamine salts and their use as dispersants for pigments and fillers.

However, the use of such products is also associated with a multitude of disadvantages: upon use in pigment pastes, high contents of dispersion additives are often required; the pigmentation levels of the pastes which can be achieved are unsatisfactorily low; the stability of the pastes and thus their viscosity constancy is inadequate; flocculation and aggregation cannot always be avoided. In many cases, there is a lack of shade constancy following storage of the pastes, and also of compatibility towards various binders. The use of known dispersion additives in many cases also adversely affects the water resistance or photostability of coating materials, and moreover additionally stabilizes the undesired foam which forms during production and processing. Also—as a result of a lack of compatibility of the dispersion resins in many coating materials—in many cases the shine is impaired in an undesired way.

There is therefore a growing need for dispersants for solids which exhibit further improved properties compared with the prior art. Dispersants which have the highest possible stabilizing effect on a large number of different solids are required.

For example, with more effective dispersants it is possible to reduce the use amount of expensive pigments without having to accept losses in colour intensity.

Furthermore, the viscosity behaviour of pastes, paints, varnishes, printing inks and other coating materials which contain dyes, solids, such as fillers and/or pigments, is essentially codetermined by the dispersant used. Here, dispersants are primarily required which bring about and also retain the lowest possible viscosity in the liquid paints and varnishes, preference being given to a Newtonian viscosity behaviour.

It was therefore the object of the present invention to find novel hyperbranched polyurethanes which are particularly suitable as dispersants for solids and exhibit an improved dispersing power and positively influence the viscosity and the rheological behaviour of formulations which contain solids.

Surprisingly, it has been found that the aforementioned object is achieved by novel hydrophilicized hyperbranched polyurethanes as dispersion resins for solids.

The invention provides hydrophilicized hyperbranched polyurethanes composed of

I) a hyperbranched polyurethane of the reaction product of
A) at least one di- and/or polyisocyanate
and
B) at least one polyol with at least 30H groups
where at least four structural units of the formula I are present in I):

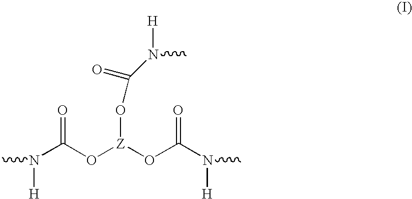

Z=linear or branched hydrocarbon radical having 3-20 carbon atoms and where, in the carbon chain, heteroatoms and/or functional groups may be contained
and
   II) one or more polyethers of the general formula (II)

T-O-B-H (II)

in which
T is a hydrogen radical and/or an if desired substituted, linear or branched aryl, arylalkyl, alkyl or alkenyl radical having 1 to 24 carbon atoms,
O=oxygen,
B corresponds to the general formula (III)

—(CₗH₂ₗO)ₐ—(CₘH₂ₘO)_{b}—(CₙH₂ₙO)_{c}-(SO)_{d}- (III)

where SO=(CH₂—CH(Ph)O)
l=2, m=3, n=4 to 20,
a, b, c independently of one another, are values from 0 to 100,
with the proviso that the sum of a+b+c is ≧0, preferably 5 to 35, in particular 10 to 20, and with the proviso that the sum of a+b+c+d is >0,
d is z 0, preferably 1 to 5.

Preferably, in formula (III), n is 4.

Examples of the di- and polyisocyanates A) used according to the invention may be any desired aromatic, aliphatic, cycloaliphatic and/or (cyclo)aliphatic di- and/or polyisocyanates.

Suitable aromatic di- or polyisocyanates A) are in principle all known compounds. 1,3- and 1,4-phenylene diisocyanate, 1,5-naphthylene diisocyanate, tolidine diisocyanate, 2,6-tolylene diisocyanate, 2,4-tolylene diisocyanate (2,4-TDI), 2,4′-diphenylmethane diisocyanate (2,4′-MDI), 4,4′-diphenylmethane diisocyanate, the mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene are particularly suitable.

Suitable aliphatic di- or polyisocyanates A) advantageously have 3 to 16 carbon atoms, preferably 4 to 12 carbon atoms, in the linear or branched alkylene radical and suitable cycloaliphatic or (cyclo)aliphatic diisocyanates advantageously have 4 to 18 carbon atoms, preferably 6 to 15 carbon atoms, in the cycloalkylene radical. (Cyclo)aliphatic diisocyanates are sufficiently understood by the person skilled in the art as meaning NCO groups which are simultaneously cyclically and aliphatically bonded, as is the case, for example, in isophorone diisocyanate. By contrast, cycloaliphatic diisocyanates are understood as meaning those which have NCO groups bonded only directly to the cycloaliphatic ring, e.g. H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate, dodecane di- and triisocyanates.

Preference is given to isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI). Very particular preference is given to using IPDI, HDI, TMDI and H₁₂MDI, it also being possible to use the isocyanurates.

4-Methylcyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenebis(cyclohexyl)diisocyanate, 1,4-diisocyanato-4-methylpentane are likewise suitable.

It is of course also possible to use mixtures of the di- and polyisocyanates A).

Furthermore, oligo- or polyisocyanates which can be prepared from the specified di- or polyisocyanates or mixtures thereof by linking by means of urethane, allophanate, urea, biuret, uretdione, amide, isocyanurate, carbodiimide, uretonimine, oxadiazinetrione or iminooxadiazinedione structures are preferably used as component A). Of particular suitability are isocyanurates, especially from IPDI and HDI.

Examples of triols B) are 1,1,1-trimethylolpropane, 1,2,5-pentanetriol, 1,2,6-hexanetriol, 1,2,7-heptanetriol, 1,2,8-octanetriol, 1,2,9-nonanetriol and 1,2,10-decanetriol, with 1,2,6-hexanetriol and 1,1,1-trimethylolpropane being very particularly preferred. It is also possible to use mixtures.

Preferably, a triol B) of the general formula (IV) is used

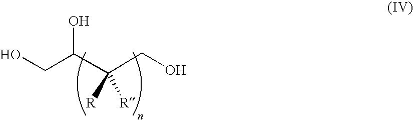

where the radicals R and R″, in each case independently of one another, are hydrogen or an alkyl group having 1 to 4 carbon atoms and n is an integer greater than 0, particularly preferably in the range from 3 to 10.

Compounds of the general formula (IV) in which R and R″ are methyl, ethyl, n-propyl, isopropyl, n-butyl, 2-butyl, tert-butyl are preferred. In a further preferred embodiment of the present invention, R and R″ are hydrogen.

Preferably, the polyurethane I) has, on number-average, at least 4 repeat units of the formula (Ib) per molecule

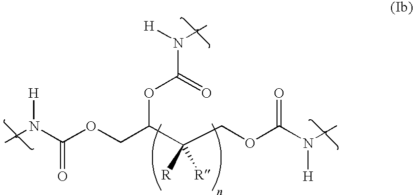

where preferably n is 3 and R and R″ are hydrogen.

According to a particularly preferred embodiment of the present invention, the polyurethane I) is obtainable by reacting a di- or polyisocyanate A) with a triol B) and at least one further diol C). Diols C) which are particularly favourable in this connection include ethylene glycol, diethylene glycol, triethylene glycol, polyethylene glycol, propylene glycol, dipropylene glycol, tripropylene glycol, polypropylene glycol, 1,2-propanediol, 1,2-butanediol, 1,4-butanediol, 1,3-butanediol, and/or 1,6-hexanediol.

The mixture of triol B) and diol C) contains, in each case based on its total weight, preferably 50.0% by weigh to <100.0% by weight of triol B) and >0.0% by weight to 50.0% by weight of diol, particularly preferably 50.0% by weight to 75.0% by weight of triol and 25.0% by weight to 50.0% by weight of diol.

The hyperbranched polyurethane I) is furthermore characterized in that it has, on number-average, at least 4, preferably at least 50, particularly preferably at least 200, very particularly preferably at least 400, repeat units of the formula (I) per molecule. The upper limit of repeat units of the formula (I) is favourably 10 000, preferably 5000 and in particular 2500 repeat units, in each case based on the number average.

The hyperbranched polyurethane I) preferably has a weight average of the molecular weight Mw in the range from 1000 g/mol to 200 000 g/mol, favourably in the range from 1500 g/mol to 100 000 g/mol, preferably in the range from 2000 g/mol to 75 000 g/mol, in particular in the range from 2500 g/mol to 50 000 g/mol.

The degree of branching of the hyperbranched polyurethane I) is expediently in the range from >10.0% to <85.0%, preferably in the range from >20.0% to 75.0%, in particular in the range from >25.0% to 65.0%.

During the preparation, the molecular weight of the hyperbranched polyurethane I) can be controlled through the relative fraction of the monomers. In order to obtain the highest possible molecular weights, the use ratio of di- or polyisocyanates A) to triol B) and if desired C) is chosen with consideration of any further comonomers present preferably in such a way that the ratio (in mol) of the reactive groups relative to one another, i.e. the ratio of the isocyanate groups to the hydroxyl groups is as close as possible to 1, preferably in the range from 5:1 to 1:5, preferably in the range from 4:1 to 1:4, particularly preferably in the range from 2:1 to 1:2, even more preferably in the range from 1.5:1 to 1:1.5 and in particular in the range from 1.01:1 to 1:1.01.

In principle, all of the polyethers which fall under the general formula (II) are suitable as component II).

The polyethers II) are generally polyalkoxyalkylenes with terminal OH groups. They are obtained through the addition of cyclic ethers, such as, for example, ethylene oxide or propylene oxide, onto mono- and/or bifunctional starter molecules. If the latter are mixed with trifunctional starters, branched reaction products can also be achieved. The starter molecules are generally monohydric and/or polyhydric alcohols, such as methanol, ethanol, ethylene glycol, 1,2-propanediol, trimethylolpropane, glycerol or sugar.

Polyethers are preferably to be understood as meaning reaction products of low molecular weight, mono- and/or polyfunctional alcohols or water with alkylene oxides. Suitable polyethers have preferably 1-5, particularly preferably 2-3, OH groups per molecule. These may either be primary or secondary.

Preferred examples of the polyether building blocks of B are radicals of alkylene oxide such as: ethylene oxide, propylene oxide, butylene oxide, styrene oxide, dodecene oxide, tetradecene oxide, 2,3-dimethyloxirane, cyclopentene oxide, 1,2-epoxypentane, 2-isopropyloxirane, glycidyl methyl ester, glycidyl isopropyl ester, epichlorohydrin, 3-methoxy-2,2-dimethyloxirane, 8-oxabicyclo[5.1.0]octane, 2-pentyloxirane, 2-methyl-3-phenyloxirane, 2,3-epoxypropylbenzene, 2-(4-fluorophenyl)oxirane, tetrahydrofuran, and pure enantiomer pairs or enantiomer mixtures thereof.

The molar ratio of isocyanate groups of the hyperbranched polymer I) to OH groups of the polyether II) is from 1:50 to 1:9, preferably from 1:20 to 1:5 and particularly preferably from 1:3 to 1:1.

The invention also provides a process for the preparation of the hydrophilicized hyperbranched polyurethanes through

1. reaction of components A) and B) to give a hyperbranched polyurethane I),
2. and then subsequent reaction of the hyperbranched polyurethane I) obtained in this way with the polyether II).

The invention further provides the use of the hydrophilicized hyperbranched polyurethanes according to the invention as dispersants of solids in liquid media, and also dispersions containing the hydrophilicized hyperbranched polyurethanes according to the invention, such as, for example, pigment pastes, coating materials, printing inks and/or printing varnishes.

Within the context of the present invention, a solid may in principle be any solid organic or inorganic material.

Examples of such solids are pigments, fillers, dyes, optical brighteners, ceramic materials, magnetic materials, nanodisperse solids, metals, biocides, agrochemicals and pharmaceuticals which are used as dispersions.

Preferred solids are pigments as are specified, for example, in the “Colour Index, Third Edition, Volume 3; The Society of Dyers and Colorists (1982)” and the subsequent revised editions.

Examples of pigments are inorganic pigments, such as carbon blacks, titanium dioxides, zinc oxides, Prussian blue, iron oxides, cadmium sulphides, chromium pigments, such as, for example, chromates, molybdates and mixed chromates and sulphates of lead, zinc, barium, calcium and mixtures thereof. Further examples of inorganic pigments are given in the book “H. Endriss, Aktuelle anorganische Bunt-Pigmente [Current Inorganic Coloured Pigments], Vincentz Verlag, Hanover (1997)”.

Examples of organic pigments are those from the group of azo, diazo, condensed azo, naphthol, metal complex, thioindigo, indanthrone, isoindanthrone, anthanthrone, anthraquinone, isodibenzanthrone, triphendioxazine, quinacridone, perylene, terylene, quaterylene, diketopyrrolopyrrole and phthalocyanine pigments. Further examples of organic pigments are given in the book “W. Herbst, K. Hunger, Industrial Organic Pigments, VCH, Weinheim (1993)”.

Further preferred solids are fillers, such as, for example, talc, kaolin, silicas, barites and chalk; ceramic materials, such as, for example, aluminium oxides, silicates, zirconium oxides, titanium oxides, boron nitrides, silicon nitrides, boron carbides, mixed silicon-aluminium nitrides and metal titanates; magnetic materials, such as, for example, magnetic oxides of transition metals, such as iron oxides, cobalt doped iron oxides and ferrites; metals, such as, for example, iron, nickel, cobalt and alloys thereof; and biocides, agrochemicals and pharmaceuticals, such as, for example, fungicides.

Pigment pastes, coating materials, printing inks and/or printing varnishes within the context of the present invention may be highly different products.

They may, for example, be systems containing fillers, pigments and/or dyes. As liquid medium, they can contain organic solvents and/or water, as is known depending on the binders used as prior art. Furthermore, binder components, such as, for example, polyols, can also be regarded as liquid media.

The coating materials, printing inks and/or printing varnishes, however, do not necessarily have to contain a liquid phase, but may also be so-called powder varnishes.

The coating materials, printing inks and/or printing varnishes can likewise contain the customary additives corresponding to the prior art, such as, for example, wetting agents, flow auxiliaries or antifoams etc. and cure, crosslink and/or dry according to various methods in accordance with the prior art.

Examples of coating materials within the context of the present invention are paints, varnishes, printing inks and other coating materials, such as solvent-containing varnishes and solvent-free varnishes, powder varnishes, UV-curable varnishes, low-solids, medium-solids, high-solids, car finishes, wood varnishes, stoving enamels, 2K varnishes, metal coating materials, toner compositions. Further examples of coating materials are defined in “Bodo Müller, Ulrich Poth, Lackformulierung und Lackrezeptur, Lehrbuch für Ausbildung und Praxis [Varnish Formulation and Varnish Formulas, Textbook For Training and Practice], Vincentz Verlag, Hanover (2003)” and “P. G. Garrat, Strahlenhärtung [Radiation Curing], Vincent Verlag, Hanover (1996)”.

Examples of printing inks and/or printing varnishes within the context of the present invention are solvent-based printing inks, flexographic printing inks, gravure printing inks, letterpress and typographic printing inks, offset printing inks, lithographic printing inks, printing inks for package printing, screen printing inks, printing inks such as printing inks for ink-jet printers, ink-jet inks, printing varnishes, such as overprint varnishes.

Examples of printing ink and/or printing varnish formulations are given in “E. W. Flick, Printing Ink and Overprint Varnish Formulations—Recent Developments, Noyes Publications, Park Ridge N.J., (1990)” and subsequent editions.

The hydrophilicized hyperbranched polyurethanes according to the invention can be co-used in pigment pastes, coating materials, printing inks and/or printing varnishes in a concentration of from 0.01 to 90.0% by weight, preferably from 0.5 to 35% by weight and particularly preferably from 1 to 25% by weight. If desired, they can be used in a mixture with wetting agents and dispersants of the prior art.

### WORKING EXAMPLES

The invention is illustrated in more detail below by reference to working examples.

### Starting Materials

### Conversion of a Di- or Polyisocyanate and a Triol to a Hyperbranched Polyisocyanate (Hyperbranched Polymer NCO)

The diisocyanate is reacted with a triol to give the hyperbranched polyisocyanate. For this, the diisocyanate and 0.005% DBTL 100% strength (calculated on the basis of the total amount) are initially introduced into a three-neck flask equipped with stirrer, internal thermometer, dropping funnel and gas inlet tube, under nitrogen blanketing. The corresponding triol, dissolved in N-methylpyrrolidone (NMP), is then slowly added dropwise at 25° C. Following the addition, the temperature is increased to 60° C. The reaction progress is monitored by means of inspecting the NCO number.

### Hyperbranched Polymer NCO 1:

Reaction (NCO:OH): 2.375 mol of IPDI:1 mol of 1,2,6-hexanetriol

| | | |
|---|---|---|
| IPDI | 131.81 | g |
| 1,2,6-Hexanetriol | 33.50 | g |
| NMP | 200.00 | g |
| Total amount | 365.31 | |

The reaction is terminated at an NCO content of 5.02%.

### Hyperbranched Polymer NCO 2:

Reaction (NCO:OH) 2.3 mol of IPDI:1 mol of 1,2,6-hexanetriol

| | |
|---|---|
| IPDI | 265.50 g |
| 1,2,6-Hexanetriol | 69.70 g |
| NMP | 520.00 g |
| Total amount | 855.20 g |

The reaction is terminated at an NCO content of 4.07%.

### Hyperbranched Polymer NCO 3:

Reaction (NCO:OH) 2.275 mol of IPDI:1 mol of 1,2,6-hexanetriol

| | |
|---|---|
| IPDI | 144.30 g |
| 1,2,6-Hexanetriol | 38.29 g |
| NMP | 200.00 g |
| Total amount | 382.59 g |

The reaction is terminated at an NCO content of 4.85%.

### Hyperbranched Polymer NCO 4:

Reaction (NCO:OH) 2.275 mol of IPDI:0.5 mol of 1,2,6-hexanetriol and 0.5 mol of trimethylolpropane (TMP)

| | |
|---|---|
| IPDI | 144.30 g |
| TMP | 19.15 g |
| 1,2,6-Hexanetriol | 19.15 g |
| NMP | 200.00 g |
| Total amount | 363.45 g |

The reaction is terminated at an NCO content of 4.85%.

### Feed Materials:

| | |
|---|---|
| Isophorone diisocyanate (IPDI) | (CAS 4098-71-9, IPDI) |
| Dibutyltin dilaurate (DBTL) | (CAS 77-58-7, DBTL) |
| 1,1,1-Trimethylolpropane (TMP) | (CAS 77-99-6, TMP) |
| 1-Methyl-2-pyrrolidone (NMP) | (CAS 872-50-4 NMP) |
| 1,2,6-Hexanetriol | (CAS 106-69-4) |

### Polyethers

The preparation of the following polyethers was carried out in accordance with the details in DE 100 29 648. The resulting modified polyethers have a general structural formula (IIa)

[R—O-(SO)ₑ(EO)_{f}(PO)_{g}(BO)ₕ]-OH (IIa)

in which

### R=see Table 1

SO=—CH2-CH(Ph)-O— where Ph=phenyl radical
EO=ethylene oxide
PO=propylene oxide
BO=butylene oxide

TABLE 1

| Polyether | R | e | f | g | h |
|---|---|---|---|---|---|
| I | Isononyl | 4 | 4 | 4 | 0 |
| II | Isononyl | 1 | 5 | 0 | 0 |
| III | Isononyl | 1 | 9 | 0 | 0 |
| IV | Butyl | 3 | 0 | 0 | 2 |
| V | Butyl | 2 | 0 | 4 | 0 |
| VI | Butyl | 0 | 9 | 0 | 0 |

In this connection, the aforementioned sequence of the monomeric alkylene oxides does not constitute any restriction with regard to the resulting polyether structures, but constitutes an exemplary list, it being expressly noted at this point that polyethers using the aforementioned monomers may have either a random or blockwise composition.

### Hydrophilicized Hyperbranched Polyurethanes According to the Invention

### EXAMPLE 1

### Hydrophilicized Hyperbranched Polyurethanes According to the Invention

Polyether I, the hyperbranched polymer NCO 1 (dissolved in butyl acetate), and catalyst diisobutyltin dilaurate (DBTL) are combined under N₂ in a three-neck flask equipped with internal thermometer, stirrer and reflux condenser. The reaction solution is heated to 50° C. The reaction is monitored by reference to the decreasing NCO content.

### Mixture for Example 1:

Molar ratio of 1 mol of NCO:1.1 mol of OH

| | | |
|---|---|---|
| Polyether I | 100.00 | g |
| Hyperbranched | 38.37 | g |
| polyisocyanate 1 | | |
| Butyl acetate | 326.08 | g (70% based on total) |
| DBTL 10% strength | 1.38 | g (1% based on solids) |
| in total | 465.83 | g |

The NCO content is monitored by regular sampling and titration. At an NCO content of <0.1%, the reaction is terminated. Following removal of the solvent, the dispersion resin 1, a highly viscous brownish liquid, was formed.

### EXAMPLES 2 to 11

### Hydrophilicized Hyperbranched Polyurethanes 2 to 11 According to the Invention

The hydrophilicized hyperbranched polyurethanes 2 to 11 were prepared analogously to Example 1 using the starting materials listed in Table 3.

TABLE 3

| | Hydrophilicized | | | NCO:OH |
|---|---|---|---|---|
| | hyperbranched | Hyperbranched | Polyethers | molar |
| Example | polyurethanes | polymers NCO I) | (PE) II) | ratio |
| 1 | 1 | 1 | I | 1:1.1 |
| 2 | 2 | 1 | IV | 1:1.5 |
| 3 | 3 | 2 | I | 1:2.8 |
| 4 | 4 | 2 | VI | 1:3 |
| 5 | 5 | 3 | VI | 1:1.6 |
| 6 | 6 | 4 | II | 1:1 |
| 7 | 7 | 2 | II | 1:2 |
| 8 | 8 | 3 | II | 1:1.3 |
| 9 | 9 | 3 | I | 1:1.5 |
| 10 | 10 | 4 | III | 1:2.5 |
| 11 | 11 | 1 | V | 1:1.5 |

### APPLICATION EXAMPLES

### Test Pigments

The following standard commercial pigments were selected from a large number of possible solids: Raven® 450 (Columbia Chemicals Co.) and Spezialschwarz® 250 (Degussa AG) as carbon black pigments, Hostaperm® Violett P-RL (Clariant International Ltd.) and Irgalit® Yellow BAW (Ciba) as typical coloured pigments.

### Test Coatings

The hydrophilicized hyperbranched polyurethanes and solids were compared in the following formulations for coatings, printing inks and/or printing varnishes:

TABLE 4
Formulation for UV-curing flexographic printing ink

| | | Carbon |
|---|---|---|
| | Org. coloured | black |
| | pigments | pigments |
| Raw materials | % by wt. | % by wt. |
| Ebecryl ® 812 (UCB) | 25.75 | 25.08 |
| Ebecryl ® 220 (UCB) | 6.57 | 6.40 |
| Laromer ® TPGDA (BASF) | 29.02 | 28.27 |
| Laromer ® TMPTA (BASF) | 16.27 | 15.85 |
| Hydrophilicized hyperbranched | 1.77 | 2.39 |
| polyurethanes | | |
| Pigment | 11.79 | 13.40 |
| Airex ® 920 (Tego) | 0.98 | 0.96 |
| Irgacure ® 1300 (Ciba) | 5.89 | 5.74 |
| Darocure ® 1173 (Ciba) | 1.96 | 1.91 |
| Total | 100.00 | 100.00 |

The ratio of amount of pigment to the amount of the hydrophilicized hyperbranched polyurethane (dispersion additive) according to the invention was kept constant in all of the experiments depending on the pigment. The ratio of hydrophilicized hyperbranched polyurethanes to pigment was in the case of carbon black pigments 17.8% of hydrophilicized hyperbranched polyurethanes (additive) based on pigment and in the case of organic coloured pigments 15% of hydrophilicized hyperbranched polyurethanes (additive) based on pigment.

TABLE 5
Formulation for white UV-curable tinting varnish

| Raw material | % by wt. |
|---|---|
| Ebecryl ® 812 (UCB) | 30.0 |
| Ebecryl ® 220 (UCB) | 8.6 |
| Laromer ® TPGDA (BASF) | 19.4 |
| Laromer ® TMPTA (BASF) | 12.9 |
| Kronos ® 1075 (KRONOS Int.) | 25.7 |
| Irgacure ® 819 (Ciba) | 1.4 |
| Darocure ® 1173 (Ciba) | 1.4 |
| Airex ® 920 (Tego) | 0.6 |

### Preparation:

The formulation constituents are weighed according to the above formulation into 250 ml screw-lid jars and glass beads (100 g of glass beads per 100 g of ground material) are added. The closed jars are then shaken in a Skandex mixer (Skandex; model: BA-S20) for 2 h at 620 rpm, during which temperatures up to 50° C. can be achieved. The glass beads are then separated from the dispersed printing ink with the help of a sieve.

### Tinted UV-Curable Flexographic Printing Ink:

For better assessment of the colour intensities, the UV-curable flexographic printing ink was mixed with the white tinting varnish. The mixings are carried out in the ratio 20:1 (41.67 g of white pigment to 1 g of org. coloured pigment; and 35.71 g of white pigment to 1 g of carbon black pigment). The mixture is then homogenized in a universal shaker (Hausschild Engineering, DAC 150 Dual Asymmetric Centrifuge) for 1 min.

### Application:

The tinted UV-curable flexographic printing inks were knife-coated onto white cardboard (Leneta) using a spiral doctor blade (24 μm). Drying was carried out with the help of a 120 W/cm mercury medium-pressure vapour lamp (Beltron GmbH, Beltron UV-Strahler). For this, the speed of the conveyor belt was 8 m/min.

### Test Methods:

In order to evaluate the efficiency of the hydrophilicized hyperbranched polyurethanes as dispersants, the colour intensities achieved, viscosity and the rheological behaviour were collated.

### Viscosity Measurement:

The rheological behaviour of the UV-curable flexographic printing ink prepared in this way is determined using a rotary viscometer. The measurement system chosen was a plate/cone system (Euro Physics, Rheo 2000 RC20, 45 μm, angle 1°; 25° C. measurement temperature).

The following velocity gradients were chosen here:

10 to 90 s⁻¹ in 30 s
100 to 1000 s⁻¹ in 40 s
1000 to 1000 s⁻¹ in 30 s
1000 to 100 s⁻¹ in 40 s
100 to 10 s⁻¹ in 30 s
90 to 10 s⁻¹ in 30 s

To compare the samples with one another, use was made of the viscosity values which were measured at the low velocity gradient of 10 s⁻¹ of the up curve since the greatest differences are to be observed here.

### Colour Measurement:

The colour measurement of the white mixture (24 μm layer thickness on Leneta cardboard) was carried out using an instrument from X-Rite (model: X-Rite SP 60). The so-called L*a*b* values were determined for all of the samples in accordance with the CIE-lab system (CIE=Commission Internationale de l'Eclairage). The CIE-lab system is useful as a three-dimensional system for the quantitative description of the colour locations. In this, the colours green (negative a values) and red (positive a* values) are plotted on one axis, and the colours blue (negative b* values) and yellow (positive b* values) are plotted on the axis arranged at a right angle to the first axis. The value C* is made up of a* and b* as follows: C*=(a*2+b*2) 0.5 and is related to the description of violet colour locations. The two axes cross at the achromatic point. The vertical axis (achromatic axis) is important for the lightness from white (L=100) to black (L=0). Using the CIE-lab system it is possible to describe not only colour locations, but also colour distances by stating the three coordinates.

### EXAMPLES 12-22

The hydrophilicized, hyperbranched polyurethanes 1 to 11 were tested in the UV-curable flexographic printing ink with the carbon black pigment Spezialschwarz® 250 as described above. The results are given in Table 6 and show that the hydrophilicized hyperbranched polyurethanes according to the invention have lower L* values than the blank sample or the comparative examples (the dispersion resin-free flexographic printing inks). Low L* values (lightness value) are desired here. The stated values in the results tables are in each case average values from three measurements.

TABLE 6
Comparison in UV-curable flexographic printing ink with
Spezialschwarz ® 250 pigment

| | Hydrophilicized | |
|---|---|---|
| | hyperbranched | |
| Example | polyurethanes | L* |
| Blank sample | — | 65.20 |
| 12 | 1 | 51.52 |
| 13 | 2 | 51.30 |
| 14 | 3 | 51.17 |
| 15 | 4 | 51.48 |
| 16 | 5 | 51.42 |
| 17 | 6 | 52.38 |
| 18 | 7 | 52.65 |
| 19 | 8 | 50.39 |
| 20 | 9 | 51.27 |
| 21 | 10 | 50.67 |
| 22 | 11 | 51.41 |
| Comparative Example 1 | No branched polyurethane | 53.36 |
| Comparative Example 2 | No branched polyurethane | 54.40 |
| Comparative Example 3 | No branched polyurethane | 55.72 |
| Comparative Example 4 | No branched polyurethane | 54.12 |

### COMPARATIVE EXAMPLES 1 to 4

The dispersants according to the prior art used were the following dispersants C1 to C4:

### Standard Commercial Aminofunctional Polyesters:

### Comparative Example C1: Solsperse® 24000 (Lubrizol Corp.)

### Comparative Example C2: Solsperse® 32000 (Lubrizol Corp.)

### Comparative Example C3: Solsperse® 39000 (Lubrizol Corp.)

### Comparative Example C4: Tego Dispers® 681 UV (Tego Chemie Service GmbH)

### EXAMPLE 23

TABLE 7
Comparison in UV-curable flexographic printing ink with
Raven ® 450 pigment

| | | Viscosity |
|---|---|---|
| | | in mPas |
| | | (10 1/s; |
| Raven ® 450 | L* | 25° C.) |
| Blank sample | 82.24 | 2591 |
| Hydrophilicized hyperbranched | 61.94 | 1959 |
| polyurethane 1 | | |
| Hydrophilicized hyperbranched | 65.65 | 1367 |
| polyurethane 2 | | |
| Hydrophilicized hyperbranched | 62.52 | 1287 |
| polyurethane 3 | | |
| Hydrophilicized hyperbranched | 67.49 | 1154 |
| polyurethane 4 | | |
| Hydrophilicized hyperbranched | 63.52 | 1993 |
| polyurethane 5 | | |
| C1 | 68.24 | 1998 |
| C2 | 60.03 | 2031 |
| C3 | 70.57 | 2049 |
| C4 | 69.09 | 2078 |

TABLE 8
Comparison in UV-curable flexographic printing ink with
Spezialschwarz ® 250 pigment

| | | Viscosity |
|---|---|---|
| | | in mPas |
| | | (10 1/s; |
| Spezialschwarz ® 250 | L* | 25° C.) |
| Blank sample | 59.28 | 962 |
| Hydrophilicized hyperbranched | 51.25 | 261 |
| polyurethane 1 | | |
| Hydrophilicized hyperbranched | 53.60 | 348 |
| polyurethane 2 | | |
| Hydrophilicized hyperbranched | 51.57 | 316 |
| polyurethane 3 | | |
| Hydrophilicized hyperbranched | 53.45 | 304 |
| polyurethane 4 | | |
| Hydrophilicized hyperbranched | 52.32 | 501 |
| polyurethane 5 | | |
| C1 | 54.24 | 603 |
| C2 | 53.98 | 715 |
| C3 | 55.29 | 820 |
| C4 | 56.16 | 874 |

Low L* (lightness values) are desired here, as is low viscosity upon small shear stresses. It is found that the hydrophilicized hyperbranched polyurethanes co-used according to the invention as dispersion resins exhibit lower L* values and lower viscosity at a given shear gradient compared with the blank sample or the comparative examples.

The positive properties of the hydrophilicized hyperbranched polyurethanes used according to the invention are limited not only to black pigments, but also extend to the other solids customarily co-used in the prior art. It is known to the person skilled in the art that particularly yellow pigments and violet pigments are difficult to disperse. Consequently, the yellow pigment Irgalite® Yellow BAW (Ciba) and Hostaperm® Violett P-RL (Clariant International Ltd.) are used below as an example of the universal applicability of the hydrophilicized hyperbranched polyurethanes as dispersion resins.

TABLE 9
Comparison in UV-curable flexographic printing ink with
Hostaperm ® Violett P-RL pigment

| | | Viscosity in mPas (10 1/s; |
|---|---|---|
| Hostaperm ® Violett P-RL | C* | 25° C.) |
| Blank sample | 34.82 | 1061 |
| Hydrophilicized hyperbranched | 36.57 | 621 |
| polyurethane 1 | | |
| Hydrophilicized hyperbranched | 37.26 | 774 |
| polyurethane 2 | | |
| Hydrophilicized hyperbranched | 36.57 | 866 |
| polyurethane 3 | | |
| Hydrophilicized hyperbranched | 36.32 | 858 |
| polyurethane 4 | | |
| Hydrophilicized hyperbranched | 36.83 | 842 |
| polyurethane 5 | | |
| C1 | 35.75 | 954 |
| C2 | 35.26 | 957 |
| C3 | 35.19 | 936 |
| C4 | 35.90 | 910 |

High C* values (violet values) and relatively low viscosity upon small shear stresses are desired. It is found that the hydrophilicized hyperbranched polyurethane co-used according to the invention exhibits lower viscosity and a higher C* value compared with the blank sample or the comparative examples.

TABLE 10
Comparison in UV-curable flexographic printing ink
Irgalite ® Yellow BAW

| | | Viscosity in mPas (10 1/s; |
|---|---|---|
| Irgalite ® Gelb BAW | b* | 25° C.) |
| Blank sample | 27.95 | 3184 |
| Hydrophilicized hyperbranched | 38.77 | 1757 |
| polyurethane 1 | | |
| Hydrophilicized hyperbranched | 42.54 | 2457 |
| polyurethane 2 | | |
| Hydrophilicized hyperbranched | 41.93 | 1943 |
| polyurethane 3 | | |
| Hydrophilicized hyperbranched | 42.58 | 2488 |
| polyurethane 4 | | |
| Hydrophilicized hyperbranched | 37.44 | 2021 |
| polyurethane 5 | | |
| C1 | 36.10 | 2543 |
| C2 | 35.25 | 2610 |
| C3 | 35.39 | 2729 |
| C4 | 36.17 | 2838 |

High b* values (yellow values) and low viscosity upon small shear stresses are desired here. It is found that the hydrophilicized hyperbranched polyurethane used according to the invention as dispersion resin exhibits lower viscosity and a higher b* value compared with the blank sample or the comparative examples.

1. A hydrophilicized hyperbranched polyurethane comprising
I) a hyperbranched polyurethane of the reaction product of
A) at least one di- and/or polyisocyanate
and
B) at least one polyol with at least 3 OH groups
where at least four structural units of the formula I are present in I): 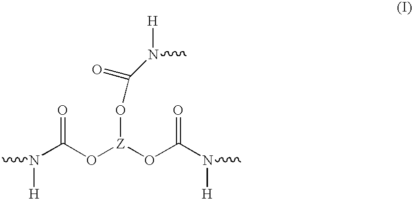
in which Z=linear or branched hydrocarbon radical having 3-20 carbon atoms and where, in the carbon chain of Z, heteroatoms and/or functional groups may be contained
and
II) one or more polyethers of the general formula (II)
T-O-B-H (II)
in which
T is a hydrogen radical and/or an if desired substituted, linear or branched aryl, arylalkyl, alkyl or alkenyl radical having 1 to 24 carbon atoms,
O=oxygen, and
B corresponds to the general formula (III)
—(CₗH₂ₗO)ₐ—(CₘH₂ₘO)_{b}—(CₙH₂ₙO)_{c}-(SO)_{d}- (III)
in which
SO=(CH₂—CH(Ph)O)
l=2, m=3, n=4 to 20,
a, b, c independently of one another, are values from 0 to 100,
with the proviso that the sum of a+b+c+d is >0, and
d is >0.

2. The hydrophilicized hyperbranched polyurethane according to claim 1,
wherein
aromatic, aliphatic, cycloaliphatic and/or (cyclo)aliphatic di- and/or polyisocyanates are used as component A).

3. The hydrophilicized hyperbranched polyurethane according claim 1,
wherein
isophorone diisocyanate (IPDI), hexamethylene diisocyanate (HDI), diisocyanato-dicyclohexylmethane (H₁₂MDI), 2-methylpentane diisocyanate (MPDI), 2,2,4-trimethyl-hexamethylene diisocyanate/2,4,4-trimethylhexamethylene diisocyanate (TMDI), norbornane diisocyanate (NBDI) are used as component A).

4. The hydrophilicized hyperbranched polyurethane according to claim 1,
wherein
urethane, allophanate, urea, biuret, uretdione, amide, isocyanurate, carbodiimide, uretonimine, oxadiazinetrione or iminooxadiazinedione structures are used.

5. The hydrophilicized hyperbranched polyurethane according to claim 1,
wherein
the component A) has isocyanurates.

6. The hydrophilicized hyperbranched polyurethane according to claim 1,
wherein
1,1,1-trimethylolpropane, 1,2,5-pentanetriol, 1,2,6-hexanetriol, 1,2,7-heptanetriol, 1,2,8-octanetriol, 1,2,9-nonanetriol and 1,2,10-decanetriol are used as component B).

7. The hydrophilicized hyperbranched polyurethane according to claim 1,
wherein
a triol B) of the general formula IV is used 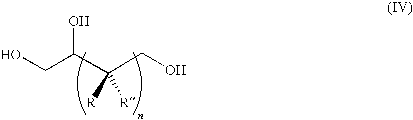
in which the radicals R and R″, in each case independently of one another, are hydrogen or an alkyl group having 1 to 4 carbon atoms and n is an integer greater than 0.

8. The hydrophilicized hyperbranched polyurethane according to claim 1,
wherein the polyurethane I) has, in the number average, at least 4 repeat units of the formula (Ib) per molecule

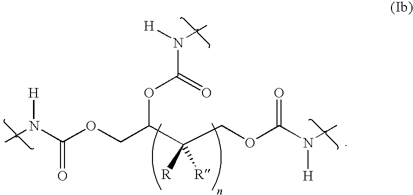

9. The hydrophilicized hyperbranched polyurethane according to claim 8,
where n is 3 and R and R″ are hydrogen.

10. The hydrophilicized hyperbranched polyurethane according to claim 1,
wherein
at least one further diol C) is used for the preparation of I).

11. The hydrophilicized hyperbranched polyurethane according to claim 10,
wherein
ethylene glycol, diethylene glycol, triethylene glycol, polyethylene glycol, propylene glycol, dipropylene glycol, tripropylene glycol, polypropylene glycol, 1,2-propanediol, 1,2-butanediol, 1,4-butanediol, 1,3-butanediol and/or 1,6-hexanediol is used as diol C).

12. The hydrophilicized hyperbranched polyurethane according to claim 1,
wherein
component I) is obtained from a monomer mixture with a molar ratio of hydroxyl groups to isocyanate groups in the range from 5:1 to 1:5.

13. The hydrophilicized hyperbranched polyurethane according to claim 1,
wherein
component I) has a weight average of the molecular weight in the range from 1000 to 200 000 g/mol.

14. The hydrophilicized hyperbranched polyurethane according to claim 1,
wherein
the polyether building blocks of B are radicals of alkylene oxides selected from the group consisting of: ethylene oxide, propylene oxide, butylene oxide, styrene oxide, dodecene oxide, tetradecene oxide, 2,3-dimethyloxirane, cyclopentene oxide, 1,2-epoxypentane, 2-isopropyloxirane, glycidyl methyl ester, glycidyl isopropyl ester, epichlorohydrin, 3-methoxy-2,2-dimethyloxirane, 8-oxabicyclo[5.1.0]octane, 2-pentyloxirane, 2-methyl-3-phenyloxirane, 2,3-epoxypropylbenzene, 2-(4-fluorophenyl)oxirane, tetrahydrofuran, and pure enantiomer pairs or enantiomer mixtures thereof.

15. A process for the preparation of the hydrophilicized hyperbranched polyurethane comprising
I) a hyperbranched polyurethane of the reaction product of
A) at least one di- and/or polyisocyanate
and
B) at least one polyol with at least 3 OH groups
where at least four structural units of the formula I are present in I): 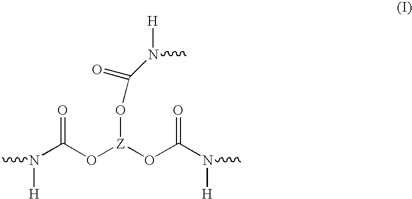
in which Z=linear or branched hydrocarbon radical having 3-20 carbon atoms and where, in the carbon chain of Z, heteroatoms and/or functional groups may be contained
and
II) one or more polyethers of the general formula (II)
T-O-B-H (II)
in which
T is a hydrogen radical and/or an if desired substituted, linear or branched aryl, arylalkyl, alkyl or alkenyl radical having 1 to 24 carbon atoms,
O=oxygen, and
B corresponds to the general formula (III)
—(CₗH₂ₗO)ₐ—(CₘH₂ₘO)_{b}—(CₙH₂ₙO)_{c}-(SO)_{d}- (III)
in which
SO=(CH₂—CH(Ph)O)
l=2, m=3, n=4 to 20,
a, b, c independently of one another, are values from 0 to 100,
with the proviso that the sum of a+b+c+d is >0, and
d is >0
through
1. reaction of components A) and B) to give a hyperbranched polyurethane I),
2. and then subsequent reaction of the hyperbranched polyurethane I) obtained in this way with the polyether II).

16. A dispersant for solids for the preparation of solvent-containing or solvent-free pigment pastes, coating materials, printing inks and/or printing varnishes comprising the hydrophilicized hyperbranched polyurethane according to claim 1.

17. A dispersant for solids for the preparation of solvent- and/or water-based pigment pastes, coating materials, printing inks and/or printing varnishes comprising the hydrophilicized hyperbranched polyurethane according to claim 1.

18. A dispersion containing at least one hydrophilicized hyperbranched polyurethane according to claim 1.
